(19) United States
(12) Patent Application Publication
(10) Pub. No.: US 2017/0193968 A1
(43) Pub. Date: Jul. 6, 2017

(54) DISPLAY PANEL AND DISPLAY APPARATUS HAVING THE SAME

(71) Applicant: BOE TECHNOLOGY GROUP CO., LTD., Beijing (CN)

(72) Inventors: Wei Wei, Beijing (CN); CHIA-CHIANG LIN, Beijing (CN)

(73) Assignee: BOE TECHNOLOGY GROUP CO., LTD., Beijing (CN)

(21) Appl. No.: 15/037,906

(22) PCT Filed: Dec. 28, 2015
(86) PCT No.: PCT/CN2015/099228

§ 371 Date: May 19, 2016

(30) Foreign Application Priority Data
Jun. 25, 2015 (CN) 201510359147.4

(51) Int. Cl. G09G 5/14; G02F 1/295; G06F 3/041

(52) U.S. Cl. CPC G09G 5/14; G06F 3/0412; G02F 1/2955

(57) ABSTRACT

The present application discloses a display panel comprising at least two display regions comprising a first display region and a second display region; the first display region comprises a first light guide having a structure which defines a first light emission angle relative to a light emission surface of the first display region; the second display region comprises a second light guide having a structure which defines a second light emission angle relative to a light emission surface of the second display region.

### CROSS-REFERENCE TO RELATED APPLICATION

This application claims priority to Chinese Patent Application No. 201510359147.4, filed Jun. 25, 2015, the contents of which are incorporated by reference in the entirety.

### TECHNICAL FIELD

The present invention relates to display technology, more particularly, to a display panel and a display apparatus having the same.

### BACKGROUND

Split screen has been commonly used in a wide range of applications. Split screen is computer graphics display technique in which a software divides graphics and text into non-movable adjacent parts. As compared to a multi-apparatus system, split screen does not require multiple display apparatuses or multiple display panels. One of the advantage of split screen display is that multi-users can look at a same display panel simultaneously. For example, in a split screen video games for two players, the display is divided into two areas, one for each player. In a split screen display mode, each player can see where the other player is and can watch the display area designated to the other player. These advantages have promoted adoption of split screen display in many applications.

### SUMMARY

In one aspect, the present invention provides a display panel comprising at least two display regions comprising a first display region and a second display region; the first display region comprises a first light guide having a structure which defines a first light emission angle relative to a light emission surface of the first display region; the second display region comprises a second light guide having a structure which defines a second light emission angle relative to a light emission surface of the second display region.

Optionally, a projection of the first light emission angle in plan view of the display panel defines a first orientation of the first light emission angle; a projection of the second light emission angle in plan view of the display panel defines a second orientation of the second light emission angle different from the first orientation.

Optionally, the first display region and the second display region are integral in one display panel.

Optionally, the display panel further comprises at least two signal input terminals, each of which connected to one of the at least two display regions for receiving image input signal into the one of the at least two display regions.

Optionally, the display panel further comprises a main display region.

Optionally, light emits from each of the at least two display regions along a direction away from the main display region and towards each of the at least two display regions, respectively.

Optionally, light emits from each of the at least two display regions along a direction away from each of the at least two display regions, respectively, and towards the main display region.

Optionally, the main display region and the at least two display regions are integral in one display panel.

Optionally, the main display region is a rectangular region, the at least two regions are four trapezoid regions, a short base of each of the four trapezoid regions abutting one side of the rectangular region, each side of each of the four trapezoid regions abutting a side of a neighboring trapezoid region, four long bases of the four trapezoid regions form the outer edge of a display region of the display panel.

Optionally, the display panel comprises a central signal input terminal connected to the main display region for receiving image input signal into the main display region, and at least two signal input terminals, each of which connected to one of the at least two display regions for receiving image input signal into the one of the at least two display regions.

Optionally, a pixel density in the main display region is smaller than a pixel density in any one of the at least two display regions.

Optionally, at least one of the first light guide and the second light guide is a grating layer.

Optionally, the grating layer comprises a plate grating.

Optionally, the plate grating comprises a plurality of inclined parallel non-transparent plates having an inclined direction relative to a light emitting surface of a display region which defines a light emission angle.

Optionally, the grating layer comprises a lens grating.

Optionally, the lens grating comprises a plurality of strips each of which having a convex surface, the lens grating having a diffraction direction relative to a light emitting surface of a display region which defines a light emission angle.

Optionally, the grating layer comprises a liquid crystal grating.

Optionally, the liquid crystal grating comprises an electrode layer and a liquid crystal layer, wherein the electrode layer has an electrode pattern for applying an electric field across the liquid crystal layer to alter the optical properties of the liquid crystal layer such that the liquid crystal grating is induced by the electrical field, the liquid crystal grating having a diffraction direction relative to a light emitting surface of a display region which defines a light emission angle.

Optionally, the display panel comprises a display component layer having a first side and a second side, the first side is a light emitting side of the display panel, the grating layer is on the first side.

Optionally, the display panel comprises a display component layer having a first side and a second side, the first side is a light emitting side of the display panel, the grating layer is on the second side.

Optionally, the display panel comprises a first backlight and a second backlight, the first light guide is part of the first backlight and the second light guide is part of the second backlight.

Optionally, the display panel comprises a display orientation controller for independently control display orientation in the at least two display regions.

Optionally, the display orientation controller comprises a plurality of field programmable gate arrays, each of which corresponds to the main display region or one of the at least two display regions.

Optionally, the display panel further comprises a touch control layer for simultaneously detecting touch signals in the at least two display regions.

In another aspect, the present invention provides a display apparatus comprising a display panel described herein.

Optionally, the display apparatus further comprises a circuit board connected to the at least two display regions, operable to independently control image display of each of the at least two display regions.

Optionally, the display apparatus further comprises a support for supporting the display panel horizontally.

Optionally, the display apparatus further comprises at least two input apparatuses, each of which corresponds to each of the at least two display regions.

Optionally, the at least two input apparatuses are at least two touch input apparatuses.

### BRIEF DESCRIPTION OF THE FIGURES

The following drawings are merely examples for illustrative purposes according to various disclosed embodiments and are not intended to limit the scope of the present invention.

FIG. 1 is a plan view of a display panel according to some embodiments.

FIG. 2 is a diagram illustrating a display panel in use according to some embodiments.

FIGS. 3A-3D are diagrams illustrating various arrangements of a main display region and a plurality of peripheral display regions in some embodiments.

FIG. 4 is a diagram illustrating the display orientation in each of the peripheral display region in a display panel according to some embodiments.

FIG. 5A is a plan view of a cross-section of a display panel showing the grating layer of a display panel in some embodiments. FIG. 5B is a cross-sectional view along the A-A′line in FIG. 5A of a display panel in some embodiments. FIG. 5C is a cross-sectional view along the A-A′line in FIG. 5A of a display panel in some embodiments.

FIG. 6A is a diagram illustrating a liquid crystal grating prior to applying an electrical field to the liquid crystal grating. FIG. 6B is a diagram illustrating a liquid crystal grating when an electrical field is applied to the liquid crystal grating.

FIGS. 7A-7C are diagrams illustrating various arrangements of a grating layer in a display panel in some embodiments.

### DETAILED DESCRIPTION

The disclosure will now describe more specifically with reference to the following embodiments. It is to be noted that the following descriptions of some embodiments are presented herein for purpose of illustration and description only. It is not intended to be exhaustive or to be limited to the precise form disclosed.

The present disclosure identifies several problems associated with split screen display technology. In a split screen display, the view angle of each area in the display cannot be independently controlled. This is because split screen is based on computer graphic processing methods. Thus, split screen is software-based and operates independent of the hardware used for display. As a result, users can view the contents in multiple display areas simultaneously. Split screen is not suitable for applications where it is not desired to allow one user to view the contents of a display area designated to another user. For this type of applications, multiple independent display apparatuses designated to multiple users are required, making it inconvenient and costly to set up such applications.

In one aspect, the present disclosure provides a superior display panel that avoids disadvantages of conventional multi-user display systems. In some embodiments, the display panel includes at least two display regions (e.g., a first display region and a second display region). The first display region comprises a first light guide having a structure which defines a first light emission angle relative to a light emission surface of the first display region. The second display region comprises a second light guide having a structure which defines a second light emission angle relative to a light emission surface of the second display region. Optionally, the light emission angle is a sharp angle. A projection of the first light emission angle in plan view of the display panel defines a first orientation of the first light emission angle (e.g., a first range of orientations). A projection of the second light emission angle in plan view of the display panel defines a second orientation of the second light emission angle (e.g., a second range of orientations). The second orientation is different from the first orientation, e.g., the second range of orientations is substantially non-overlapping with the first range of orientations. Optionally, the second orientation (e.g., an average of a second range of orientations) differs from the first orientation (e.g., an average of a first range of orientations) by more than 5°, 10°, 15°, 20°, 25°, 30°, 35°, 40°, 45°, 50°, 55°, 60°, 65°, 70°, 75°, 80°, 85°, 90°, 95°, 100°, 120°, or 150°. Because the first orientation is different from the second orientation, the present display panel allows a user keeping the contents of the image display to herself, i.e., each user may only view the image display in a region designated to her. Thus, multiple users may each use one of the display regions for image display and touch control. The image display on each of the display regions can be independently controlled and may have a same or different image display.

In some embodiments, the first light emission angle is the same as the second light emission angle. In some embodiments, the first light emission angle is different from the second light emission angle.

The at least two display regions may be integral in one display panel or may be assembled together as one piece by a user. Optionally, the at least two display regions may be at least two split screen regions, i.e., the at least two display regions are defined by a software, e.g., split screen technique. The image display in the at least two display regions may be independently controlled. In some embodiments, the display panel further includes at least two signal input terminals, each of which connected to one of the at least two display regions for receiving image input signal into the one of the at least two display regions. For example, a display apparatus having the display panel may further includes a circuit board connected to the at least two signal input terminals for independently controls image display of each of the at least two display regions. Optionally, the display panel further includes a display orientation controller for independently control display orientation in the at least two display regions. For example, the display orientation controller may include a plurality of field programmable gate arrays, each of which corresponds to one of the at least two display regions, for independent image control in these regions. Optionally, the display panel includes both the at least two signal input terminal and the display orientation controller.

In some embodiments, the display panel further includes a main display region. Optionally, the main display region and the at least two display regions may be integral in one display panel or may be assembled together as one piece by a user. The image display in the main display region and the at least two display regions may be independently controlled. Optionally, at least one of the first light emission angle and the second light emission angle is away from the main display region and towards each of the at least two display regions. Optionally, at least one of the first light emission angle and the second light emission angle is away from each of the at least two display regions and towards the main display region. Optionally, the display panel further includes a display orientation controller for independently control display orientation in the main display region and the at least two display regions. For example, the display orientation controller may include a plurality of field programmable gate arrays, each of which corresponds to the main display region or one of the at least two display regions, for independent image control in these regions. Optionally, the display panel includes both the at least two signal input terminal and the display orientation controller.

In some embodiment, the main display region includes a light guide for defining a light emission angle for the main display region. In some embodiment, the main display region does not have a light guide. In some embodiment, the main display region includes a light guide having a structure which defines a main light emission angle relative to a light emission surface of the main display region. Optionally, a projection of the main light emission angle in plan view of the display panel defines a main orientation of the main light emission angle. Optionally, the main orientation covers all sides of the main display region. Optionally, the main display region has at least two main orientations, each of which corresponds to the first orientation for the first display region and the second orientation for the second display region.

In some embodiments, the display panel further includes a touch control layer for simultaneously detecting touch signals in the main display region and the at least two display regions. The touch control can be an on-cell touch control, an in-cell touch control or a hover touch control. Optionally, the touch signal occurred in multiple display regions may be simultaneously detected and processed. Optionally, the pixel density in the main display region is smaller than the pixel density in any one of the at least two display regions.

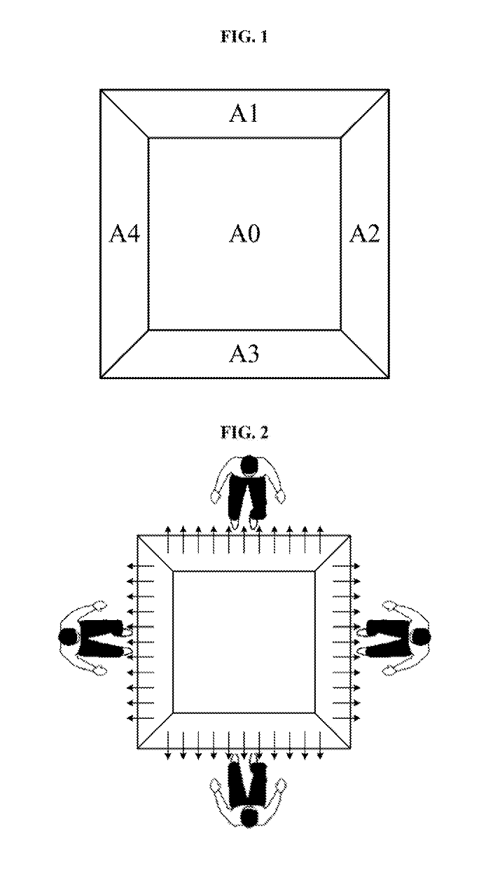

FIG. 1 is a plan view of a display panel according to some embodiments. Referring to FIG. 1, the display panel in the embodiment includes a main display region A0 and four peripheral display regions A1, A2, A3, and A4 on each side of the main display region A0. As shown in FIG. 1, the main display region in the embodiment is a rectangular region, the at least two peripheral regions are four trapezoid regions. A short base of each of the four trapezoid regions abuts one side of the rectangular region or a square region. Each side of each of the four trapezoid regions abuts a side of a neighboring trapezoid region. Four long bases of the four trapezoid regions form the outer edge of a display region of the display panel. Putting all together, the entire display region has a rectangular or square shape. Each peripheral region includes a light guide having a structure which defines a light emission angle relative to a light emission surface of the peripheral display region. For example, the light emission angle may be in a direction away from the main display region and towards each of the at least two peripheral display regions. In some embodiments, the main display region surrounds the outer edges of the peripheral regions. In those cases, the light emission angle is in a direction away from each of the at least two peripheral display regions and towards the main display region.

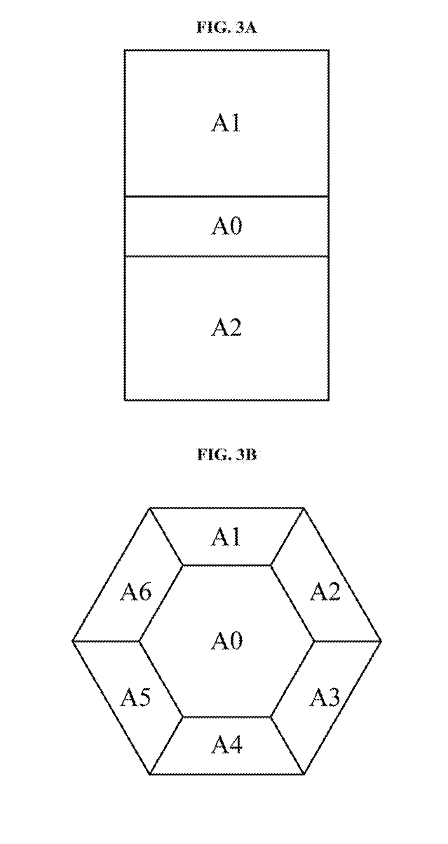

FIG. 2 is a diagram illustrating a display panel in use according to some embodiments. Referring to FIG. 2, the projections (as indicated by arrows) of four light emission angles in plan view of the display panel have four different orientations. Each orientation is in a direction towards a user. The light emission angle for each peripheral display region is restricted by the light guide within a certain range, the contents of the display within a particular peripheral display region may only be viewed by a user from a view angle overlapping with the light emission angle. In other words, the contents of the display may not be viewed by a user from a view angle outside the light emission angle range. In FIG. 1, four light emission angles are oriented towards four different directions, i.e., four orientations corresponding to four users. Each peripheral display panel may only be viewed from a certain orientation and within a certain view angle.

Referring to FIG. 2, each peripheral display region (e.g., A2 region on the right side of the main display region) includes a light guide for defining a light emission angle (e.g., an A2 light emission angle). The projection of the A2 light emission angle in plan view of the display panel is in a direction towards the right side of the display panel. The projections of light emission angles of other peripheral display regions (e.g., A1, A3, and A4 regions) are in a direction different from that of the A2 region. For example, the orientations of the light emission angles for A1, A3, and A4 are the left side, the upper side and the lower side of the display panel. All four orientations are different from each other, thus the contents of the display in each peripheral display region can be viewed from only one side of the display panel, e.g., each side by one single user.

Depending on the shape of the peripheral display region, each peripheral display region may have a substantially uniform distribution of orientations of light emission angles, or a non-uniform distribution of orientations of light emission angles. In some display panels, the peripheral display region may be a curved display region (e.g., a half circle or a quarter circle). In such cases, the orientations of light emission angles may be still in a direction substantially towards one direction (e.g., the right side) of the display panel. However, a curved peripheral display panel may not have a uniform distribution of individual orientations. Instead, the orientations of the light emission angles may gradually vary along the curvature of the peripheral display panel. Even though the distribution of orientations of light emission angles is non-uniform, the orientations are still substantially restricted to one direction (e.g., the right direction), ensuring that the contents of the display can only by viewed from one direction of the display panel, e.g., by one user.

In some embodiments, the display panel include a first display region including a first light guide having a structure which defines a first light emission angle relative to a light emission surface of the first display region and a second display region including a second light guide having a structure which defines a second light emission angle relative to a light emission surface of the second display region. A projection of the first light emission angle in plan view of the display panel defines a first range of orientations of the first light emission angle. A projection of the second light emission angle in plan view of the display panel defines a second range of orientations of the second light emission angle. Optionally, the first range of orientations is substantially non-overlapping with the second range of orientations.

By having a light guide in each of the display regions, the light emission of the display region is limited to a light emission angle or a range of light emission angles relative to the light emission surface of the display region. The image display in such a display region cannot be viewed in all view angles but may only be viewed from a limited view angle defined by the light guide. This structure makes it possible to make a single display panel having multiple display regions, each of which is viewable from only one non-overlapping orientation. Accordingly, multiple display apparatuses are not needed for applications that demand multiple exclusive view points for multiple users. In addition, the present display panel can simultaneously detect touch signals in multiple display regions, making it suitable for a wide range of applications, including entertainment apparatus.

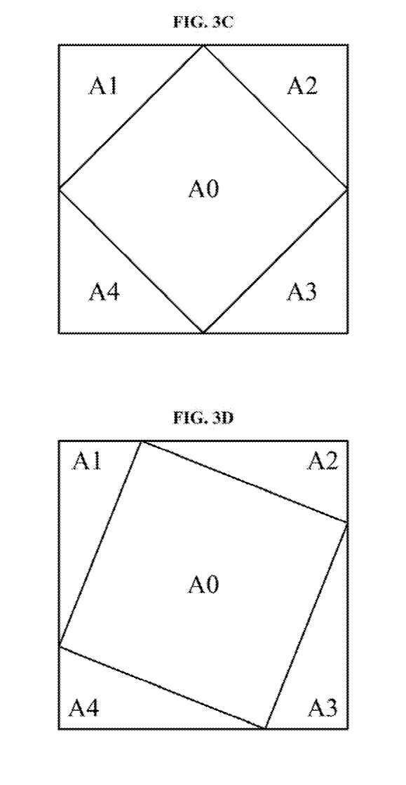

FIGS. 3A-3D are diagrams illustrating various arrangements of a main display region and a plurality of peripheral display regions in some embodiments. Referring to FIG. 3A, the display panel in the embodiment include a main display region A0 and two peripheral display regions A1 and A2 on two sides of the main display region A0. The display panel is suitable for applications having 2-3 users.

Referring to FIG. 3B, the display panel in the embodiment include a main display region A0 and six peripheral display regions A1, A2, A3, A4, A5, and A6 on six sides of the main display region. As shown in FIG. 3B, the main display region in the embodiment is a hexagonal region, and the six peripheral regions are six trapezoid regions. A short base of each of the six trapezoid regions abuts one side of the hexagonal region. Each side of each of the six trapezoid regions abuts a side of a neighboring trapezoid region. Six long bases of the six trapezoid regions form the outer edge of a display region of the display panel. Putting all together, the entire display region has a hexagonal shape. The display panel in the embodiment is suitable for applications having 2-6 users.

Numerous alternative embodiments may be practiced. Various arrangements of main display region and peripheral display regions in the display panel may be designed. For example, for display panels having a rectangular or square shape, other methods of arranging peripheral display regions and main display region may be applied. Referring to FIGS. 3C and 3D, the display panels in the embodiments illustrate alternative arrangements of four peripheral display regions A1, A2, A3, and A4 surrounding a main display region A0. The display panels in the embodiments are suitable for applications having 2-4 users. The display panel can be made of any appropriate shape, including, but are not limited to, a triangle, a circle, a pentagon, an octagon, an ellipse, etc.

The present display panel finds a wide range of applications such as entertainment applications, including, but are not limited to, entertainment system for board games, card games, mahjong, pool games, etc.

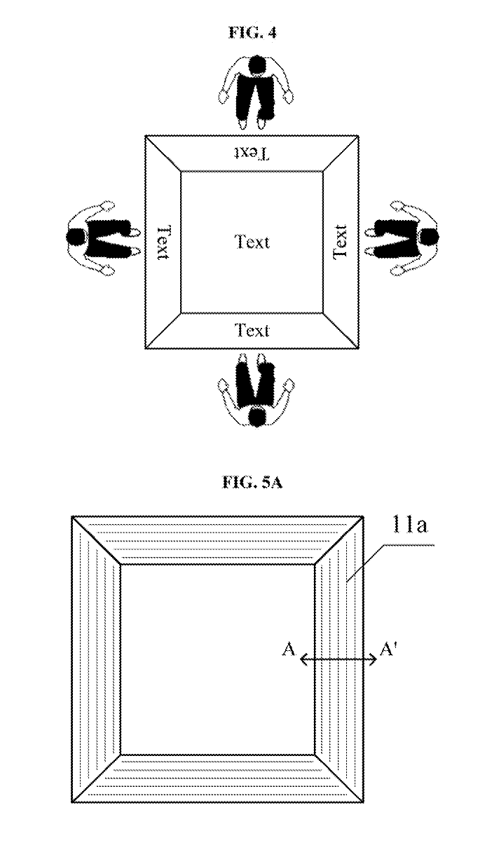

FIG. 4 is a diagram illustrating the display orientation in each of the peripheral display region in a display panel according to some embodiments. Referring to FIG. 4, the display panel in the embodiment is a rectangular or square shape display panel for four users. The display panel includes a main display region in the center and four peripheral display regions on four sides of the main display region. Four peripheral display regions have four different display orientations for image display. FIG. 4 illustrates the image display of an exemplary image “Text” in the main display region and four peripheral display regions. The four peripheral display regions have four different display orientations for the image “Text”, one towards the right side of the display panel, one towards the left side, one towards the upper side, and the last towards the lower side of the display panel. Optionally, the image display in the main display region is viewable from all four sides of the display panel, e.g., by four users. Optionally, the main display region does not have a light guide so that the view angle is not limited. In some embodiments, the display orientation in a peripheral display region is substantially the same as a projection of the light emission angle in plan view of the display panel.

For simultaneously displaying image in the main display region and the peripheral display regions, the display panel may directly receive image signals pre-processed for the main display region and the peripheral display regions, respectively. In some embodiments, the display panel includes multiple signal input terminals, each of which connected to one peripheral display regions for receiving image input signal into the one peripheral display regions. Optionally, the display panel may further include a signal input terminal connected to the main display region for receiving image input signal into the main display region. In some embodiments, the display panel includes a display orientation controller for independently control display orientation in the main display region and the peripheral display regions. For example, the display orientation controller may include a plurality of field programmable gate arrays, each of which corresponds to one of the peripheral display regions or the main display region. Optionally, the display panel may include both a display orientation controller and multiple signal input terminals.

In some embodiments, the light guide includes a grating layer. The grating layer has a grating structure that defines a light emission angle relative to a light emission surface of a display region.

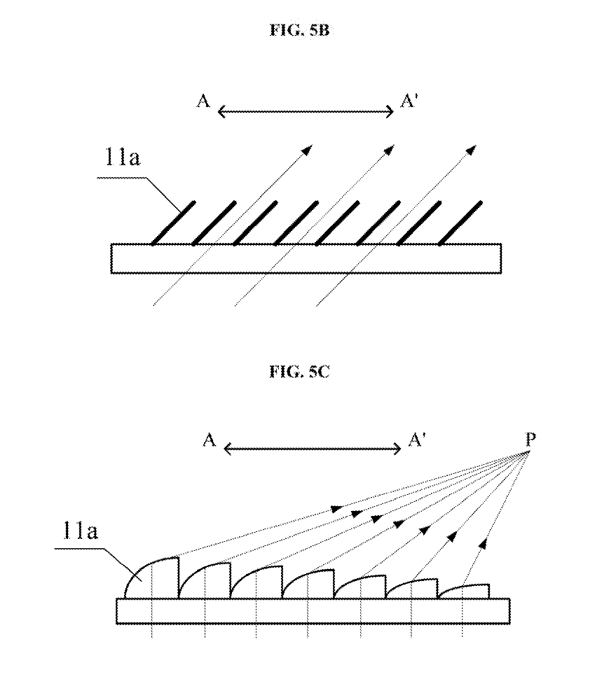

FIG. 5A is a plan view of a cross-section of a display panel showing the grating layer of a display panel in some embodiments. Referring to FIG. 5A, the grating layer in the embodiment is a plate grating 11a. For example, the plates of the plate grating 11a in a peripheral display region A2 are arranged along a direction from the main display region A0 towards the peripheral display region A2. Similarly, the plates of the plate grating 11a in other peripheral display regions (A1, A3, and A4) are arranged along a direction from the main display region A0 towards a peripheral display region (A1, A3, or A4).

FIG. 5B is a cross-sectional view along the A-A′line in FIG. 5A of a display panel in some embodiments. Referring to FIG. 5B, the plate grating 11a includes a plurality of inclined parallel non-transparent plates having an inclined direction relative to a light emitting surface of a display region which defines a light emission angle (e.g., by reflection, diffraction and/or absorption). The inclined direction of the plate grating 11a may be adjustable. For example, the inclined direction may be adjusted depending on various applications, thereby changing the light emission angle of the display region. Optionally, the display panel may be designed to have real time control of the inclined direction.

FIG. 5C is a cross-sectional view along the A-A′line in FIG. 5A of a display panel in some embodiments. Referring to FIG. 5C, the grating layer in the embodiment is a lens grating 11a. As shown in FIG. 5C, the lens grating 11a includes a plurality of strips each of which having a convex surface. The lens grating 11a has a diffraction direction relative to a light emitting surface of a display region which defines a light emission angle. As shown in FIG. 5C, each strip includes a convex surface and two orthogonal planes. The convex surfaces in the plurality of strips vary over the lens grating 11a such that the light diffracted by the strips all focus on one view point (point P in FIG. 5C). Therefore, FIG. 5C shows an exemplary grating layer which defines a light emission angle relative to a light emission surface of the display region by diffraction. Brightness and display quality can be greatly enhanced by using such a grating layer. Numerous alternative embodiments of lens grating may be practiced. For example, the strips of the lens grating may have different shapes (e.g., a concavo-convex shape) and/or arrangements.

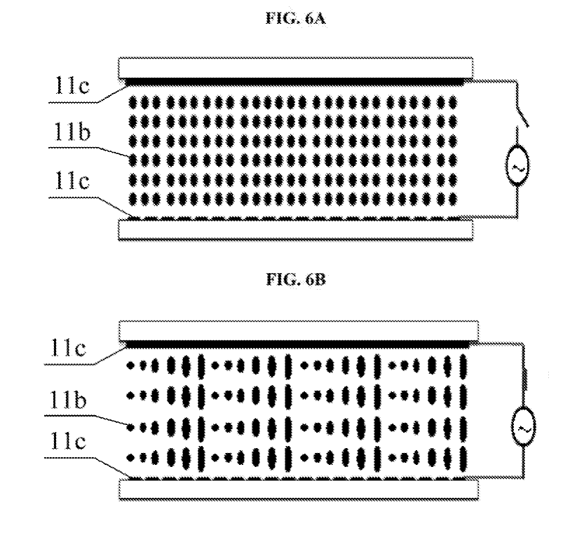

In some embodiments, the grating layer includes a liquid crystal grating. FIG. 6A is a diagram illustrating a liquid crystal grating prior to applying an electrical field to the liquid crystal grating. Referring to FIG. 6A, the liquid crystal grating includes two electrode layers 11c and a liquid crystal layer 11b sandwiched by the two electrode layers 11c. The liquid crystal layer 11b is in a transparent state when an electrical field is not applied. FIG. 6B is a diagram illustrating a liquid crystal grating when an electrical field is applied to the liquid crystal grating. The two electrode layers 11c have an electrode pattern for applying an electric field across the liquid crystal layer 11b to alter the optical properties of the liquid crystal layer 11b such that a liquid crystal grating is induced by the electrical field. The liquid crystal grating has a diffraction direction relative to a light emitting surface of a display region which defines a light emission angle.

Numerous alternative embodiments of liquid crystal grating may be practiced. For example, various embodiments of electrical fields can be applied to create the liquid crystal grating, analogous to those for creating a liquid crystal layer in a liquid crystal display panel (e.g., an Advance Super Dimension Switch type or a Twisted Nematic type liquid crystal display panel). Accordingly, various embodiments of electrode arrangements can be practiced to create the liquid crystal grating. In some liquid crystal gratings, the electrode layer 11c is on only one side of the liquid crystal layer 11b. Optionally, a liquid crystal grating may be combined with a polarizer for defining the light emission angle.

By having a liquid crystal grating, the light emission angle in a display region such as a peripheral display region can be controllable and/or adjustable. For example, the limited view angle based on the light emission angle provided by the liquid crystal grating may be switched on or off. This increases the flexibility in using the present display panels and enhances display quality.

In some embodiments, the display region includes a backlight. Optionally, the light guide is part of the backlight, i.e., the backlight is a directional backlight. The light provided by the backlight emits along a light emission angle relative to a light emission surface of the display region. Optionally, the light guide is a structure covering the light emitting apparatus of the backlight. Optionally, the light guide is a grating layer in the backlight. Optionally, the light guide is a plate grating (e.g., FIG. 5B) or a lens grating (e.g., FIG. 5C). Optionally, the light guide is a light guide plate for defining a light emission angle. A directional backlight thus only emits light at a certain view angle or within a certain range of view angles. There is not image display outside the defined range of view angles. Thus, using a directional backlight for defining the light emission angle may achieve excellent display quality without compromising brightness and/or resolution. Optionally, the display region may include a combination of a directional backlight and a light grating. In such display regions, the light emission angles of the directional backlight and the light grating may be aligned to prevent reduction of brightness.

The present display panel may be used in connection with any appropriate types of display technology, including, but are not limited to, organic light emitting diode (OLED) and liquid crystal display (LCD).

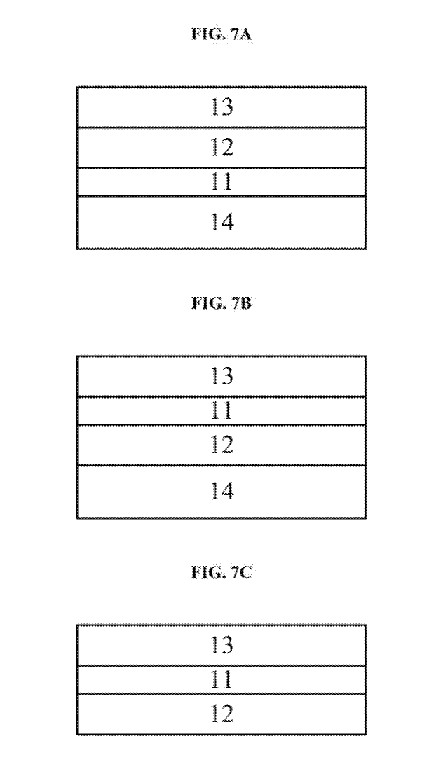

FIGS. 7A-7C are diagrams illustrating various arrangements of a grating layer in a display panel in some embodiments. Referring to FIG. 7A, the display panel in the embodiment include a backlight 14, a grating layer 11, a display component layer 12, and a touch control layer 13. The display component layer 12 is the layer having a pixel of a display panel. For example, the display component layer 12 in a liquid crystal display panel includes, e.g., a thin film transistor, two substrates facing each other, a pixel electrode, a liquid crystals, etc. The display component layer 12 in an organic light emitting display panel includes, e.g., a light emitting layer, a cathode, an anode, etc. The display component layer 12 has a first side and a second side, the first side being a light emitting side of the display panel. As shown in FIG. 7A, the grating layer 11 is on the second side of the display component layer 12. Optionally, the display panel is a liquid crystal display panel.

Referring to FIG. 7B, the display panel in the embodiment include a backlight 14, a display component layer 12, a grating layer 11, and a touch control layer 13. The display component layer 12 has a first side and a second side, the first side being a light emitting side of the display panel. As shown in FIG. 7B, the grating layer 11 is on the first side of the display component layer 12. Optionally, the display panel is a liquid crystal display panel.

Referring to FIG. 7C, the display panel in the embodiment include a display component layer 12, a grating layer 11, and a touch control layer 13. The display component layer 12 has a first side and a second side, the first side being a light emitting side of the display panel. As shown in FIG. 7C, the grating layer 11 is on the first side of the display component layer 12. Optionally, the display panel is an organic light emitting display panel.

In some embodiments, the display panel includes a touch control layer 13. Optionally, the touch control layer 13 simultaneously detects touch signals in the peripheral display regions. Optionally, the touch control layer 13 simultaneously detects touch signals in the peripheral display regions and the main display region. By having a touch control layer 13 that simultaneously detects touch signals in multiple display regions, simultaneously interactions among multiple users can be made possible. Optionally, the number of touch points that can be simultaneously detects is no less than the number of peripheral display regions, or no less than the number of peripheral display regions and main display region. Optionally, the touch control layer 13 includes a plurality of sub-layers, each of which simultaneously detects touch signals in each of the peripheral display regions or the main display region. Optionally, a display region includes a plurality of touch control sub-regions. Optionally, the touch control layer 13 simultaneously detects touch signals in each of the touch control sub-regions. Numerous alternatively embodiments of multi-point, simultaneous touch control may be practiced.

In some embodiments, a pixel density in the main display region is smaller than a pixel density in any one of the at least two display regions. Optionally, the pixel density (e.g., as defined by pixels per inch) may be determined by the distance between a display region and a user. By having an appropriate pixel density in each of the display regions, the manufacturing costs may be reduced without compromising display quality.

In another aspect, the present disclosure also provides a display apparatus having a display panel described herein. Optionally, the display apparatus includes a circuit board connected to the at least two display regions, operable to independently control image display of each of the at least two display regions. Optionally, the display apparatus includes a support for supporting the display panel horizontally. Optionally, the display apparatus includes at least two input apparatuses, each of which corresponds to each of the at least two display regions. Optionally, the at least two input apparatuses are at least two touch input apparatuses. Examples of display apparatuses include, but are not limited to, an electronic paper, a mobile phone, a tablet computer, a television, a notebook computer, a digital album, a gps, etc. The display apparatus can also be a multi-user entertainment system or a display portion thereof.

By having a light guide in each of the display regions, the light emission of the display region is limited to a light emission angle or a range of light emission angles relative to the light emission surface of the display region. The image display in such a display region cannot be viewed in all view angles but may only be viewed from a limited view angle defined by the light guide. This structure makes it possible to make a single display panel having multiple display regions, each of which is viewable from only one non-overlapping orientation. Accordingly, multiple display apparatuses are not needed for applications that demand multiple exclusive view points for multiple users. In addition, the present display panel can simultaneously detect touch signals in multiple display regions, making it suitable for a wide range of applications, including entertainment apparatuses.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A display panel, comprising:
at least two display regions comprising a first display region and a second display region;
the first display region comprises a first light guide having a structure which defines a first light emission angle relative to a light emission surface of the first display region;
the second display region comprises a second light guide having a structure which defines a second light emission angle relative to a light emission surface of the second display region.

2. The display panel of claim 1, wherein a projection of the first light emission angle in plan view of the display panel defines a first orientation of the first light emission angle; a projection of the second light emission angle in plan view of the display panel defines a second orientation of the second light emission angle different from the first orientation.

3. The display panel of claim 1, wherein the first display region and the second display region are integral in one display panel.

4. The display panel of claim 1, further comprising at least two signal input terminals, each of which connected to one of the at least two display regions for receiving image input signal into the one of the at least two display regions.

5. The display panel of claim 1, further comprising a main display region.

6. (canceled)

7. (canceled)

8. The display panel of claim 5, wherein the main display region and the at least two display regions are integral in one display panel.

9. The display panel of claim 5, wherein the main display region is a rectangular region, the at least two regions are four trapezoid regions, a short base of each of the four trapezoid regions abutting one side of the rectangular region, each side of each of the four trapezoid regions abutting a side of a neighboring trapezoid region, four long bases of the four trapezoid regions form the outer edge of a display region of the display panel.

10. The display panel of claim 5, wherein the display panel comprises a central signal input terminal connected to the main display region for receiving image input signal into the main display region, and at least two signal input terminals, each of which connected to one of the at least two display regions for receiving image input signal into the one of the at least two display regions.

11. The display panel of claim 5, a pixel density in the main display region is smaller than a pixel density in any one of the at least two display regions.

12. The display panel of claim 1, wherein at least one of the first light guide and the second light guide is a grating layer.

13. The display panel of claim 12, wherein the grating layer comprises a plate grating.

14. The display panel of claim 13, wherein the plate grating comprises a plurality of inclined parallel non-transparent plates having an inclined direction relative to a light emitting surface of a display region which defines a light emission angle.

15. The display panel of claim 12, wherein the grating layer comprises a lens grating.

16. The display panel of claim 15, wherein the lens grating comprises a plurality of strips each of which having a convex surface, the lens grating having a diffraction direction relative to a light emitting surface of a display region which defines a light emission angle.

17. The display panel of claim 12, wherein the grating layer comprises a liquid crystal grating.

18. The display panel of claim 17, wherein the liquid crystal grating comprises an electrode layer and a liquid crystal layer, wherein the electrode layer has an electrode pattern for applying an electric field across the liquid crystal layer to alter the optical properties of the liquid crystal layer such that the liquid crystal grating is induced by the electrical field, the liquid crystal grating having a diffraction direction relative to a light emitting surface of a display region which defines a light emission angle.

19. (canceled)

20. (canceled)

21. (canceled)

22. The display panel of claim 1, wherein the display panel comprises a display orientation controller for independently control display orientation in the at least two display regions.

23. The display panel of claim 22, wherein the display orientation controller comprises a plurality of field programmable gate arrays, each of which corresponds to the main display region or one of the at least two display regions.

24. The display panel of claim 1, further comprising a touch control layer for simultaneously detecting touch signals in the at least two display regions.

25. A display apparatus comprising a display panel of claim 1.

26. (canceled)

27. (canceled)

28. (canceled)

29. (canceled)
